(19) United States
(12) Patent Application Publication
(10) Pub. No.: US 2024/0135567 A1
(43) Pub. Date: Apr. 25, 2024

(54) METHOD AND SYSTEM FOR EVALUATING VEGETATION CONNECTIVITY

(71) Applicants: Chinese Academy of Surveying & Mapping, Beijing (CN); IGSNRR, Chinese Academy of Sciences, Beijing (CN)

(72) Inventors: Ying ZHANG, Beijing (CN); Wei SONG, Beijing (CN); Qinghua QIAO, Beijing (CN)

(73) Assignees: Chinese Academy of Surveying & Mapping, Beijing (CN); IGSNRR, Chinese Academy of Sciences, Beijing (CN)

(21) Appl. No.: 18/460,829

(22) Filed: Sep. 5, 2023

(30) Foreign Application Priority Data
Sep. 5, 2022 (CN) 202211077160.7

(51) Int. Cl. G06T 7/60; G06T 17/20

(52) U.S. Cl. CPC G06T 7/60; G06T 17/20; G06V 20/188

(57) ABSTRACT

Some embodiments of the disclosure provide methods and systems for evaluating vegetation connectivity. In some embodiments, the disclosure provide a method including: acquiring vegetation patch vector data of a research area, extracting a geometric center from the vegetation patch vector data, and constructing the geometric center into a network node combination; constructing, according to a split-and-merge algorithm, the network node combination into Delaunay triangulation networks that are connected to but not overlap with each other; calculating and summarizing connectivity between a patch to which each node in the Delaunay triangulation network belongs and a patch to which an adjacent node belongs, to obtain overall connectivity between the patch to which each node belongs and the patch to which the adjacent node belongs; and performing spatial integrated expression processing on connectivity of each independent patch to obtain a spatial measurement result of vegetation connectivity of the research area.

### CROSS REFERENCE TO RELATED APPLICATIONS

This application claims priority to Chinese Patent Application Number 202211077160.7, filed on Sep. 5, 2022, the disclosure of which is incorporated by reference herein in its entirety.

### FIELD OF THE DISCLOSURE

The disclosure relates generally to the field of ecological quality evaluation. More specifically, the disclosure relates to methods and systems for evaluating vegetation connectivity.

### BACKGROUND

Vegetation is an important part of landscape, and plays an important role in controlling water and soil loss, improving microclimate, and providing green and shade open space. Maintaining good vegetation connectivity is one of key factors to protect ecosystem stability and integrity, and is also an important guarantee to achieve an ecological function effect. Therefore, in ecological restoration, improving vegetation connectivity is often regarded as an important target of ecological restoration.

The vegetation is an ecological landscape. For measurement of the vegetation connectivity, refer to related evaluation methods on connectivity and the like in landscape ecology. Commonly used methods mainly include the following: (1) Corridor evaluation method. A corridor serves as a passage between different habitats in fragmented landscapes and serves as a communication bridge. Evaluations of the corridor, such as a landscape corridor density index and a number of habitats connected by a corridor, are mostly based on a connectivity evaluation method in a sense of ecological function implementation. (2) Graph theory (GT)-based landscape index. These models simplify complex landscapes into networks including nodes and links. An integral index of connectivity (IIC) and a probability of connectivity (PC) are commonly used. (3) GT-based connectivity index. This type of index usually does not consider a landscape function and performs an evaluation only from a structure perspective, and currently, is mainly used in evaluation working of concentrated connectivity of farmland. However, this type of processing modes usually simply treat a connection relationship between two blocks as 0-1, ignoring influence of a distance between the two blocks. In terms of expressions of calculation results, these models are based on independent accounting of patches, without considering expressions of spatial relationships. Expression results are spatial visualization based on distributed patches.

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

Some embodiments of the disclosure provide a method and a system for evaluating vegetation connectivity.

According to a first aspect, the present disclosure provides a method for evaluating vegetation connectivity, including the following steps:

S1: Acquire vegetation patch vector data of a research area, extract a geometric center from the vegetation patch vector data, and construct the geometric center into a network node combination.

S2: Construct, according to a split-and-merge (SM) algorithm, the network node combination into Delaunay triangulation networks that are connected to but not overlap with each other.

S3: Calculate and summarize connectivity between a patch to which each node in the Delaunay triangulation networks belongs and a patch to which an adjacent node belongs, to obtain overall connectivity between the patch to which each node belongs and the patch to which the adjacent node belongs.

S4: Perform spatial integrated expression processing on connectivity of each independent patch by using overall connectivity of each patch as a weight by using a kernel density estimation (KDE) function, to obtain a spatial measurement result of vegetation connectivity of the research area.

In some embodiments, the step of “acquiring vegetation patch vector data of a research area” in S1 further includes:

S11: Obtain the vegetation patch vector data of the research area by using a high-resolution remote sensing (HRRS) image by means of visual interpretation (VI), object-oriented (OO) extraction, supervised classification (SC), unsupervised classification (USC), or deep learning (DL), or by directly acquiring a vegetation interpretation patch of the research area.

In some embodiments, the step of “extracting a geometric center from the vegetation patch vector data” in S1 further includes:

S12: Calculate coordinates of a geometric center of a vegetation patch based on coordinates of each vertex of the vegetation patch vector data, where an expression is as follows:

$$x = {\sum }_{i = 1}^{n} \frac{{x}_{i}}{n} ; \qquad y = {\sum }_{i = 1}^{n} \frac{{y}_{i}}{n} ,$$

where

x and y are respectively a horizontal coordinate and a vertical coordinate of a geometric center of a patch; xᵢ is a horizontal coordinate value of a vertex i; yᵢ is a vertical coordinate value of the vertex i; and n is a number of vertices of a vegetation patch.

In some embodiments, S2 specifically includes the following steps:

S21: Split, by using a recursive algorithm, all data of the network node combination constructed in step S1, and split a raw data domain into multiple sub-blocks, to enable each sub-block to include an equal number of point sets.

S22: Generate a boundary for each sub-block according to a Graham convex hull algorithm.

S23: Perform triangulation on each sub-block, and perform optimization by using a local optimization (LOP) algorithm.

S24: Search for a bottom line and a top line of a convex hull boundary of the sub-block, and perform merging from bottom to top starting from the bottom line to generate the Delaunay triangulation networks.

In some embodiments, a specific process of the “Graham convex hull algorithm” in S22 is as follows:

S221: Find a point with a minimum vertical coordinate in each point set.

S222: Connect the point with the minimum vertical coordinate and other points in the point set by using line segments, and calculate included angles between the line segments and a horizontal line.

S223: Sort data points according to the included angles, or sort the data points according to distances if the included angles are the same.

S224: Connect all the data points according to sorting to obtain a polygon.

In some embodiments, a specific process of S23 is as follows:

S230: Perform triangulation on the point sets of each sub-block to form multiple triangle sets.

S231: Combine any two triangles with common edges in the triangle sets of each sub-block into one quadrilateral.

S232: Check, according to a maximum empty circle rule, whether any vertex in the quadrilateral is in a circumscribed circle of a triangle formed by the other three vertices.

S233: If yes, reverse diagonals of the quadrilateral to complete an LOP process.

In some embodiments, S3 includes the following steps:

S31: According to a distance between each node and the adjacent node in the Delaunay triangulation networks and areas of the patch to which each node belongs and the patch to which the adjacent node belongs, calculate connectivity between patches to which adjacent nodes in the triangulation network belong, where a calculation equation is as follows:

$${L}_{ij} = \frac{{D}_{i} * {D}_{j}}{1 + {S}_{ij}}$$

S32: Summarize connectivity between the patch to which each node belongs and the patch to which the adjacent node belongs, to obtain the overall connectivity of each patch, where a calculation equation is as follows:

Lᵢ=Σⱼ₌₁^{m}Lᵢⱼ, where

Lᵢⱼ is vegetation connectivity between a patch i and an adjacent patch j; Dᵢ and Dⱼ are respectively an area of the patch i and an area of the patch j; Sᵢⱼ is a minimum distance between geometric centers of the patch i and the patch j; and Lᵢ is overall connectivity between the patch i and the patch to which the adjacent node belongs.

In some embodiments, S4 further includes:

calculating a kernel function of each patch by using a KDE equation, and performing normalization processing to obtain a probability density function (PDF) of a kernel density, where a calculation equation is as follows:

$${f}_{n} ( x ) = \frac{1}{nh} {\sum }_{i = 1}^{n} k ( \frac{x - {x}_{i}}{h} ) ,$$

where

ƒₙ(X) is a KDE function at a valuation point x, and n is a number of points in a bandwidth range; k is a kernel weighting function, and h is a bandwidth, namely, a width of extension in space of a curved surface whose origin is x, and a value of h affects smoothness of a graph; and x−xᵢ is a distance between density estimation points x and xᵢ.

According to a second aspect, the present disclosure provides a system for evaluating vegetation connectivity, including:

a node construction module, configured to: acquire vegetation patch vector data of a research area, extract a geometric center from the vegetation patch vector data, and construct the geometric center into a network node combination;

an SM module, configured to construct, according to an SM algorithm, the network node combination into Delaunay triangulation networks that are connected to but not overlap with each other;

a connectivity calculation module, configured to calculate and summarize connectivity between a patch to which each node in the Delaunay triangulation networks belongs and a patch to which an adjacent node belongs, to obtain overall connectivity between the patch to which each node belongs and the patch to which the adjacent node belongs; and

an expression measurement module, configured to perform spatial integrated expression processing on connectivity of each independent patch by using overall connectivity of each patch as a weight by using a KDE function, to obtain a spatial measurement result of vegetation connectivity of the research area.

In some embodiments, the SM module includes:

a node split submodule, configured to split, by using a recursive algorithm, all data of the network node combination constructed in step S1, and split a raw data domain into multiple sub-blocks, to enable each sub-block to include an equal number of point sets;

a boundary creation submodule, configured to generate a boundary for each sub-block according to a Graham convex hull algorithm;

an LOP submodule, configured to perform triangulation on each sub-block, and perform optimization by using an LOP algorithm; and

a boundary merge submodule, configured to search for a bottom line and a top line of a convex hull boundary of the sub-block, and perform merging from bottom to top starting from the bottom line to generate the Delaunay triangulation networks.

### BRIEF DESCRIPTION OF THE DRAWINGS

Illustrative embodiments of the present disclosure are described in detail below with reference to the attached drawing figures.

FIG. 1 is a flowchart of a method for evaluating vegetation connectivity according to an embodiment of the disclosure.

FIG. 2 is a sub-flowchart of step S1 according to an embodiment of the disclosure.

FIG. 3 is a sub-flowchart of step S2 according to an embodiment of the disclosure.

FIG. 4 is a sub-flowchart of step S3 according to an embodiment of the disclosure.

FIG. 5 is an example diagram of a geometric center of a vegetation patch according to an embodiment of the disclosure.

FIG. 6 is an example diagram of constructing a triangulation network according to an embodiment of the disclosure.

FIG. 7 is a schematic diagram of spatial integrated expression of area vegetation connectivity according to an embodiment of the disclosure.

### DETAILED DESCRIPTION

The following describes some non-limiting exemplary embodiments of the invention with reference to the accompanying drawings. The described embodiments are merely a part rather than all of the embodiments of the invention. All other embodiments obtained by a person of ordinary skill in the art based on the embodiments of the disclosure shall fall within the scope of the disclosure.

The principles and features of the present disclosure are described below with reference to the accompanying drawings. The listed embodiments are only used to explain the present disclosure, rather than to limit the scope of the present disclosure.

To make the objectives, features and advantages of this application more comprehensible, the present disclosure is further described below with reference to the accompanying drawings and embodiments. It can be understood that the described embodiments are merely some rather than all of the embodiments of the present disclosure. The embodiments described herein are merely intended to explain the present disclosure, rather than to limit this application. All other embodiments obtained by persons of ordinary skill in the art based on the described embodiments of this application shall fall within the protection scope of this application.

It should be noted that relational terms herein such as “first” and “second” are merely used to distinguish one entity or operation from another entity or operation without necessarily requiring or implying any actual such relationship or order between such entities or operations.

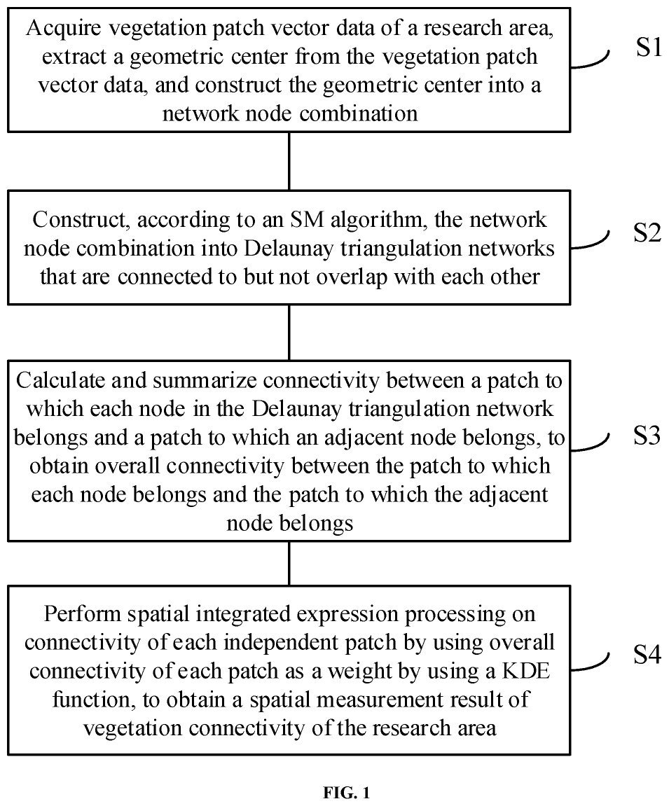

FIG. 1 is a flowchart of a method for evaluating vegetation connectivity according to an embodiment of the disclosure.

With reference to FIG. 1, the method for evaluating vegetation connectivity may include the following steps:

S1: Acquire vegetation patch vector data of a research area, extract a geometric center from the vegetation patch vector data, and construct the geometric center into a network node combination.

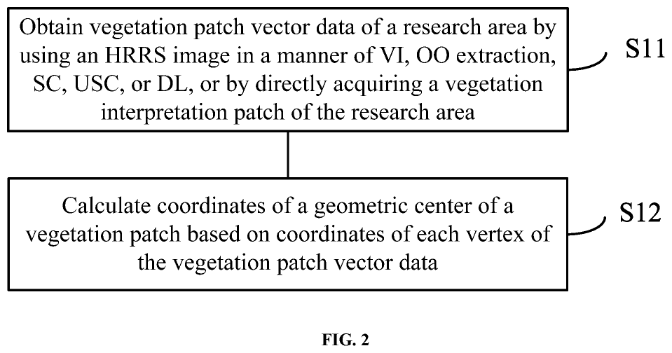

In some embodiments, with reference to FIG. 2, namely, a sub-flowchart of step S1 of this application, the step of “acquiring vegetation patch vector data of a research area” in step S1 may further include:

S11: Obtain the vegetation patch vector data of the research area by using an HRRS image by means of VI, OO extraction, SC, USC, or DL, or by directly acquiring a vegetation interpretation patch of the research area.

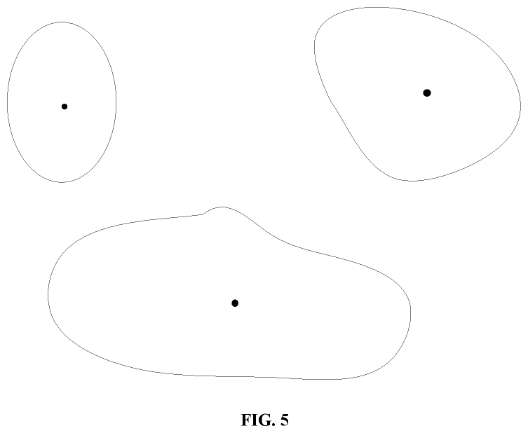

In some embodiments, with reference to FIG. 5, namely, an example diagram of a geometric center of a vegetation patch, the step of “extracting a geometric center from the vegetation patch vector data” in step S1 may further include:

S12: Calculate coordinates of the geometric center of the vegetation patch based on coordinates of each vertex of the vegetation patch vector data, where an expression is as follows:

$$x = {\sum }_{i = 1}^{n} \frac{{x}_{i}}{n} ; \qquad y = {\sum }_{i = 1}^{n} \frac{{y}_{i}}{n} ,$$

where

x and y are respectively a horizontal coordinate and a vertical coordinate of a geometric center of a patch; xᵢ is a horizontal coordinate value of a vertex i; yᵢ is a vertical coordinate value of the vertex i; and n is a number of vertices of a vegetation patch.

Specifically, in this method, the vegetation patch vector data of the research area is obtained by using the HRRS image in the manner of VI, OO extraction, SC, USC, or DL, or by directly acquiring the vegetation interpretation patch of the research area. In addition, specific conditions need to be considered for geometric centers of vegetation patches due to different shapes of the vegetation patches. Usually, for a patch including n vertices, coordinates of a geometric center of the patch are average values of coordinates of the vertices. By calculating centers of the vertices, the coordinates of the geometric center of the patch can be obtained.

S2: Construct, according to an SM algorithm, the network node combination into Delaunay triangulation networks that are connected to but not overlap with each other.

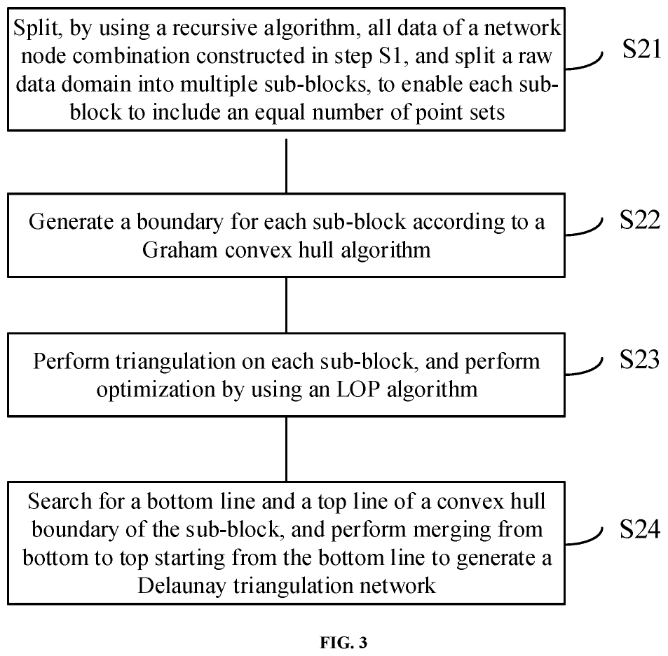

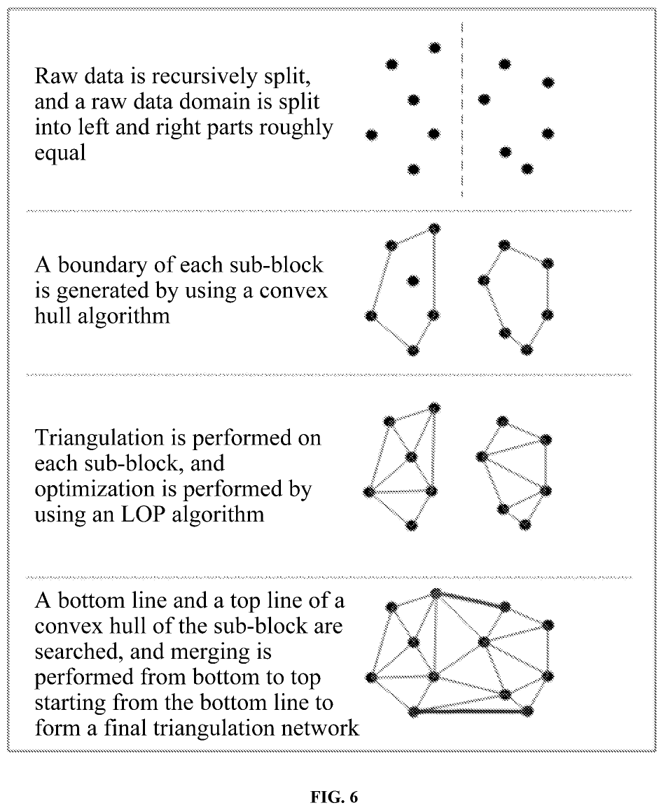

In some embodiments, with reference to FIG. 3, namely, a sub-flowchart of step S2 of this application, and FIG. 6, namely, a schematic diagram of constructing a triangulation network, step S2 specifically may include the following steps:

S21: Split, by using a recursive algorithm, all data of the network node combination constructed in step S1, and split a raw data domain into multiple sub-blocks, to enable each sub-block to include an equal number of point sets.

S22: Generate a boundary for each sub-block according to a Graham convex hull algorithm.

In some embodiments, a specific process of the “Graham convex hull algorithm” in step S22 is as follows:

S221: Find a point with a minimum vertical coordinate in each point set.

S222: Connect the point with the minimum vertical coordinate and other points in the point set by using line segments, and calculate included angles between the line segments and a horizontal line.

S223: Sort data points according to the included angles, or sort the data points according to distances if the included angles are the same.

S224: Connect all the data points according to sorting to obtain a polygon.

Specifically, the boundary of each sub-block is generated by using the Graham convex hull algorithm. A specific algorithm process is as follows: (1) Find a point (assumed to be P1) with a minimum vertical coordinate in a point set. (2) Connect P1 and other points by using line segments, and calculate included angles between the line segments and the horizontal line. (3) Sort data points according to the included angles, or sort the data points according to distances if the included angles are the same. It is assumed that an obtained point sequence is P1, P2, . . . , and Pn. (4) Connect all the points in sequence to obtain a polygon. According to a theorem that “each vertex of a convex polygon must be on a same side of any edge of the polygon”, a non-convex hull vertex in a boundary sequence is deleted, and a convex hull point set is obtained. (5) Connect the points in sequence to obtain a convex hull boundary of each split field.

S23: Perform triangulation on each sub-block, and perform optimization by using an LOP algorithm.

In some embodiments, a specific process of step S23 is as follows:

S230: Perform triangulation on the point sets of each sub-block to form multiple triangle sets.

S231: Combine any two triangles with common edges in the triangle sets of each sub-block into one quadrilateral.

S232: Check, according to a maximum empty circle rule, whether any vertex in the quadrilateral is in a circumscribed circle of a triangle formed by the other three vertices.

S233: If yes, reverse diagonals of the quadrilateral to complete an LOP process.

Specifically, after the boundary of each sub-block is generated by using the Graham convex hull algorithm, each sub-block is first split into the multiple triangle sets by using the triangulation, and then triangles with common edges are combined into quadrilaterals. Next, whether the any vertex in the quadrilateral is in the circumscribed circle of the triangle formed by the other three vertices is checked according to the maximum empty circle rule. If yes, the diagonals of the quadrilateral are reversed to complete the LOP process.

S24: Search for a bottom line and a top line of a convex hull boundary of the sub-block, and perform merging from bottom to top starting from the bottom line to finally form the Delaunay triangulation network.

Specifically, after the foregoing steps are completed, the convex hull boundary of each sub-block can be found. Triangle combination is performed from bottom to top starting from the bottom line to finally form the Delaunay triangulation network.

S3: Calculate and summarize connectivity between a patch to which each node in the Delaunay triangulation network belongs and a patch to which an adjacent node belongs, to obtain overall connectivity between the patch to which each node belongs and the patch to which the adjacent node belongs.

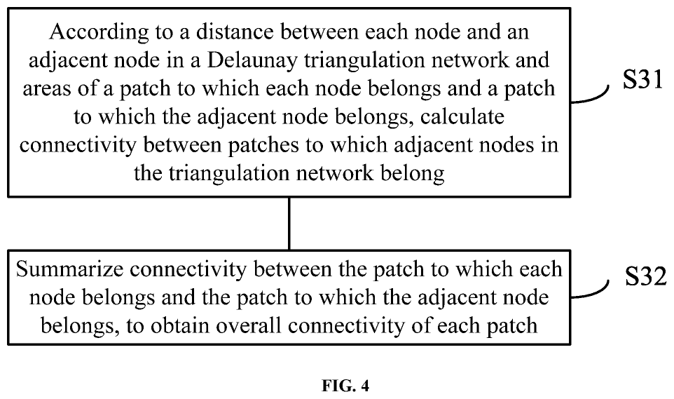

In some embodiments, with reference to FIG. 4, namely, a sub-flowchart of step S3 of this application, the step S3 specifically may include the following steps:

S31: According to a distance between each node and the adjacent node in the Delaunay triangulation network and areas of the patch to which each node belongs and the patch to which the adjacent node belongs, calculate connectivity between patches to which adjacent nodes in the triangulation network belong, where a calculation equation is as follows:

$${L}_{ij} = \frac{{D}_{i} * {D}_{j}}{1 + {S}_{ij}}$$

S32: Summarize connectivity between the patch to which each node belongs and the patch to which the adjacent node belongs, to obtain overall connectivity of each patch, where a calculation equation is as follows:

Lᵢ=Σ^{m}ⱼ₌₁Lᵢⱼ, where

Lᵢⱼ is vegetation connectivity between a patch i and an adjacent patch j; Dᵢ and Dⱼ are respectively an area of the patch i and an area of the patch j; Sᵢⱼ is a minimum distance between geometric centers of the patch i and the patch j; and Lᵢ is overall connectivity between the patch i and the patch to which the adjacent node belongs.

Specifically, after the vegetation connection network constructed by vegetation patches is obtained, connectivity between the vegetation patches may be calculated. After the connectivity between each patch and the patch to which the adjacent node belongs is obtained by using the calculation equation, results are summarized to obtain the overall connectivity of each patch relative to the patch to which the adjacent node belongs.

S4: Perform spatial integrated expression processing on connectivity of each independent patch by using the overall connectivity of each patch as a weight by using a KDE function, to obtain a spatial measurement result of vegetation connectivity of the research area.

In some embodiments, step S4 may further include:

calculating a kernel function of each patch by using a KDE equation, and performing normalization processing to obtain a PDF of a kernel density, where a calculation equation is as follows:

$${f}_{n} ( x ) = \frac{1}{nh} {\sum }_{i = 1}^{n} k ( \frac{x - {x}_{i}}{h} ) ,$$

where

ƒₙ(X) is a KDE function at a valuation point x, and n is a number of points in a bandwidth range; k is a kernel weighting function, and h is a bandwidth, namely, a width of extension in space of a curved surface whose origin is x, and a value of h affects smoothness of a graph; and x−xᵢ is a distance between density estimation points x and xᵢ.

Specifically, the vegetation connectivity is not expression at a level of a single patch, but should be spatial integrated expression under interaction with the patch to which the adjacent node belongs. Therefore, in this method, a KDE-based spatial integrated expression manner is constructed by considering an interaction relationship between the patches to which the adjacent node belongs. The KDE is to use a smooth peak function (namely, “kernel”) to fit observed data points, thereby simulating a real probability distribution curve. The KDE refers to a non-parametric method for estimating a PDF. Assuming that there are n sample points with an independent and identically distributed (IID) F, it is assumed that a PDF of the IID F is f. When probability distribution of a thing is known, if a number appears during observation, it is considered that a probability density of the number is very large, a probability density of a number close to the number is relatively large, and a probability density of a number far away from the number is relatively small. Based on this idea, for a first number during observation, K may be used to fit a probability density. For multiple probability density distribution functions obtained by fitting each observed number, a degree of importance is set through averaging or according to a weight. It should be noted that the KDE is used not to find a true distribution function, but to obtain N kernel functions by using the kernel function to use data and bandwidth of each data point as parameters of the kernel function. Linear superposition and normalization processing is further performed, to obtain the PDF of the kernel density.

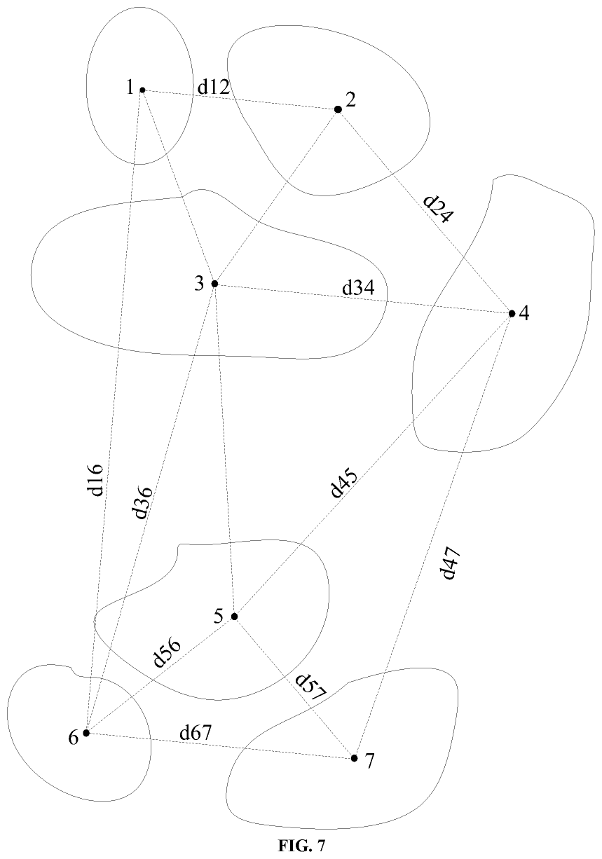

FIG. 7 is a schematic diagram of spatial integrated expression of area vegetation connectivity according to an embodiment of the disclosure. Here, geometric centers of vegetation patches extracted in step S1 are numbers 1 to 7 in FIG. 7. Each number represents a geometric center of one vegetation patch, and d₁₂, d₂₄, d₃₄, and other parameters in FIG. 7 are shortest distances between geometric centers of adjacent patches. The overall connectivity of each patch can be calculated in step S3, to draw the schematic diagram of the spatial integrated expression of the area vegetation connectivity.

A second aspect of this application further provides a system for evaluating vegetation connectivity, which may include:

a node construction module, configured to: acquire vegetation patch vector data of a research area, extract a geometric center from the vegetation patch vector data, and construct the geometric center into a network node combination;

an SM module, configured to construct, according to an SM algorithm, the network node combination into Delaunay triangulation networks that are connected to but not overlap with each other;

a connectivity calculation module, configured to calculate and summarize connectivity between a patch to which each node in the Delaunay triangulation network belongs and a patch to which an adjacent node belongs, to obtain overall connectivity between the patch to which each node belongs and the patch to which the adjacent node belongs; and

an expression measurement module, configured to perform spatial integrated expression processing on connectivity of each independent patch by using overall connectivity of each patch as a weight by using a KDE function, to obtain a spatial measurement result of vegetation connectivity of the research area.

In some embodiments, the SM module may include:

a node split submodule, configured to split, by using a recursive algorithm, all data of the network node combination constructed in step S1, and split a raw data domain into multiple sub-blocks, to enable each sub-block to include an equal number of point sets;

a boundary creation submodule, configured to generate a boundary for each sub-block according to a Graham convex hull algorithm;

an LOP submodule, configured to perform triangulation on each sub-block, and perform optimization by using an LOP algorithm; and

a boundary merge submodule, configured to search for a bottom line and a top line of a convex hull boundary of the sub-block, and perform merging from bottom to top starting from the bottom line to generate the Delaunay triangulation network.

In addition, those skilled in the art can understand that, although some embodiments herein include some features included in other embodiments but not other features, a combination of features of different embodiments falls within the scope of this application and forms a different embodiment.

Those skilled in the art can understand that descriptions of the embodiments have respective focuses. For a part not described in detail in one embodiment, refer to related descriptions in other embodiments.

Although the embodiments of this application are described with reference to the accompanying drawings, various modifications and variations can be made by those skilled in the art without departing from the spirit and scope of this application. Such modifications and variations are within the scope of the appended claims. The foregoing merely describes specific implementations of the present disclosure, but the protection scope of the present disclosure is not limited thereto. Any person skilled in the art can easily conceive various equivalent modifications or replacements within the technical scope of the present disclosure, and these modifications or replacements shall fall within the protection scope of the present disclosure. Therefore, the protection scope of the present disclosure should be subject to the protection scope of the claims.

Various embodiments of the disclosure may have one or more of the following effects. Some embodiments of the disclosure provide a method and a system for evaluating vegetation connectivity provided in the present disclosure which may help to resolve technical problems in prior art.

In some embodiments, the disclosure may provide the method and the system for evaluating vegetation connectivity. During evaluating ecological spatial connectivity of vegetation, an influence factor of a patch distance is introduced, and a quantitative evaluation index of spatial connectivity of the vegetation can be constructed with reference to a GT-based landscape index and a GT-based connectivity index. According to this index, the vegetation connectivity may be quantitatively measured in space, and a connection breakpoint of the vegetation may be found as a key area for ecological restoration.

In other embodiments, by improving the vegetation connectivity, biodiversity and species migration in space may be promoted.

In further embodiments, to be more intuitive in expression, the KDE function may be introduced to create an interpolation plane based on a density of the vegetation connectivity, implementing visual representation of spatial probability distribution of the vegetation connectivity.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

1.-10. (canceled)

11. A method for evaluating vegetation connectivity, comprising:
S1 acquiring vegetation patch vector data of a research area, extracting a geometric center from the vegetation patch vector data, and constructing the geometric center into a network node combination;
S2 constructing, according to a split-and-merge (SM) algorithm, the network node combination into Delaunay triangulation networks that are connected to but not overlapped with each other,
wherein S2 comprises:
S21 splitting, by a recursive algorithm, all data of the network node combination constructed in step S1, and splitting a raw data domain into multiple sub-blocks, to enable each sub-block to comprise an equal number of point sets;
S22 generating a boundary for each sub-block according to a Graham convex hull algorithm;
S23 performing triangulation on each sub-block, and performing optimization by a local optimization (LOP) algorithm; and
S24 searching for a bottom line and a top line of a convex hull boundary of the sub-block, and performing merging from bottom to top starting from the bottom line to generate the Delaunay triangulation networks;
S3 calculating and summarizing connectivity between a patch to which each node in the Delaunay triangulation networks belongs and a patch to which an adjacent node belongs, to obtain overall connectivity between the patch to which each node belongs and the patch to which the adjacent node belongs,
wherein S3 comprises:
S31 according to a distance between each node and the adjacent node in the Delaunay triangulation networks and areas of the patch to which each node belongs and the patch to which the adjacent node belongs, calculating connectivity between patches to which adjacent nodes in the triangulation network belong, wherein a calculation equation is as follows:
$${L}_{ij} = \frac{{D}_{i} * {D}_{j}}{1 + {S}_{ij}}$$
and
S32 summarizing connectivity between the patch to which each node belongs and the patch to which the adjacent node belongs, to obtain the overall connectivity of each patch, wherein a calculation equation is as follows:
Lᵢ=Σ^{m}ⱼ₌₁Lᵢⱼ
wherein:
Lᵢⱼ is vegetation connectivity between a patch i and an adjacent patch j,
Dᵢ and Dⱼ are an area of the patch i and an area of the patch j,
Sᵢⱼ is a minimum distance between geometric centers of the patch i and the patch j; and
Lᵢ is overall connectivity between the patch i and the patch to which the adjacent node belongs; and
S4 performing spatial integrated expression processing on connectivity of each independent patch by overall connectivity of each patch as a weight by a kernel density estimation (KDE) function, to obtain a spatial measurement result of vegetation connectivity of the research area,
wherein S4 comprises calculating a kernel function of each patch by a KDE equation, and performing normalization processing to obtain a probability density function (PDF) of a kernel density, wherein a calculation equation is as follows:
$${f}_{n} ( x ) = \frac{1}{nh} {\sum }_{i = 1}^{n} k ( \frac{x - {x}_{i}}{h} ) ,$$
wherein:
ƒₙ(X) is a KDE function at a valuation point x, and n is a number of points in a bandwidth range;
k is a kernel weighting function, and h is a width of extension in space of a curved surface whose origin is x, and a value of h affects smoothness of a graph; and
x−xi is a distance between density estimation points x and xi.

12. The method according to claim 11, wherein the acquiring vegetation patch vector data of a research area in S1 comprises S11 obtaining the vegetation patch vector data of the research area by a high-resolution remote sensing (HRRS) image by visual interpretation (VI), object-oriented (OO) extraction, supervised classification (SC), unsupervised classification (USC), or deep learning (DL), or by directly acquiring a vegetation interpretation patch of the research area.

13. The method according to claim 12, wherein the extracting a geometric center from the vegetation patch vector data in S1 comprises S12 calculating coordinates of a geometric center of a vegetation patch based on coordinates of each vertex of the vegetation patch vector data according to the following equation:
$$x = {\sum }_{i = 1}^{n} \frac{{x}_{i}}{n} ; \qquad y = {\sum }_{i = 1}^{n} \frac{{y}_{i}}{n} ,$$
wherein:
x and y are a horizontal coordinate and a vertical coordinate of a geometric center of a patch;
xi is a horizontal coordinate value of a vertex i;
yi is a vertical coordinate value of the vertex i; and
n is a number of vertices of a vegetation patch.

14. The method according to claim 11, wherein a process of the Graham convex hull algorithm in S22 comprises:
S221 finding a point with a minimum vertical coordinate in each point set;
S222 connecting the point with the minimum vertical coordinate and other points in the point set by line segments, and calculating included angles between the line segments and a horizontal line;
S223 sorting data points according to the included angles, or sorting the data points according to distances if the included angles are the same; and
S224 connecting all the data points according to sorting to obtain a polygon.

15. The method according to claim 14, wherein a process of S23 comprises:
S230 performing triangulation on the point sets of each sub-block to form multiple triangle sets;
S231 combining two triangles with common edges in the triangle sets of each sub-block into one quadrilateral;
S232 checking, according to a maximum empty circle rule, whether any vertex in the quadrilateral is in a circumscribed circle of a triangle formed by the other three vertices; and
S233 if yes, reversing diagonals of the quadrilateral to complete an LOP process.

16. A system for evaluating vegetation connectivity, comprising:
a node construction module configured to: acquire vegetation patch vector data of a research area, extract a geometric center from the vegetation patch vector data, and construct the geometric center into a network node combination; and
an SM module configured to construct, according to an SM algorithm, the network node combination into Delaunay triangulation networks that are connected to but not overlap with each other;
wherein the SM module comprises:
a split submodule configured to split, by a recursive algorithm, all data of a constructed network node combination, and split a raw data domain into multiple sub-blocks, to enable each sub-block to comprise an equal number of point sets; and
a connectivity calculation module configured to calculate and summarize connectivity between a patch to which each node in the Delaunay triangulation networks belongs and a patch to which an adjacent node belongs, to obtain overall connectivity between the patch to which each node belongs and the patch to which the adjacent node belongs;
wherein connectivity calculation module comprises:
an adjacent connectivity calculation submodule configured to: according to a distance between each node and the adjacent node in the Delaunay triangulation networks and areas of the patch to which each node belongs and the patch to which the adjacent node belongs, calculate connectivity between patches to which adjacent nodes in the triangulation network belong, wherein a calculation equation is as follows:
$${L}_{ij} = \frac{{D}_{i} * {D}_{j}}{1 + {S}_{ij}}$$
a summarizing submodule configured to summarize connectivity between the patch to which each node belongs and the patch to which the adjacent node belongs, to obtain the overall connectivity of each patch, wherein a calculation equation is as follows:
Lᵢ=Σ^{m}ⱼ₌₁Lᵢⱼ
wherein:
Lᵢⱼ is vegetation connectivity between a patch i and an adjacent patch j;
Dᵢ and Dⱼ are an area of the patch i and an area of the patch j;
Sᵢⱼ is a minimum distance between geometric centers of the patch i and the patch j; and
Lᵢ is overall connectivity between the patch i and the patch to which the adjacent node belongs;
an expression measurement module configured to perform spatial integrated expression processing on connectivity of each independent patch by overall connectivity of each patch as a weight by a KDE function, to obtain a spatial measurement result of vegetation connectivity of the research area;
wherein the expression measurement module comprises a normalization submodule, configured to calculate a kernel function of each patch by a KDE equation, and performing normalization processing to obtain a probability density function (PDF) of a kernel density, wherein a calculation equation is as follows:
$${f}_{n} ( x ) = \frac{1}{nh} {\sum }_{i = 1}^{n} k ( \frac{x - {x}_{i}}{h} ) ,$$
wherein:
ƒₙ(X) is a KDE function at a valuation point x, and n is a number of points in a bandwidth range;
k is a kernel weighting function, and h is a width of extension in space of a curved surface whose origin is x, and a value of h affects smoothness of a graph; and
x−xᵢ is a distance between density estimation points x and xᵢ.
